(19) United States
(12) Patent Application Publication
(10) Pub. No.: US 2017/0317850 A1
(43) Pub. Date: Nov. 2, 2017

(54) Layer-3 Forwarding in VXLAN

(71) Applicant: HANGZHOU H3C TECHNOLOGIES CO., LTD., Zhejiang (CN)

(72) Inventors: Liwei HUANG, Beijing (CN); Wei WANG, Beijing (CN)

(21) Appl. No.: 15/529,783

(22) PCT Filed: Nov. 24, 2015
(86) PCT No.: PCT/CN2015/095403

§ 371 Date: May 25, 2017

(30) Foreign Application Priority Data
Nov. 25, 2014 (CN) 201410690750.6

(51) Int. Cl. H04L 12/46; H04L 12/741

(52) U.S. Cl. CPC H04L 12/4641; H04L 12/4633; H04L 45/74

(57) ABSTRACT

A SDN controller receives a packet sent by a VTEP to be forwarded at the layer-3. The SDN controller may determine at least one VXLAN gateway that could reach the destination node of the packet and which is located in the same VXLAN with a source node of the packet, as a forwarding gateway. After forwarding gateway is determined, the SDN controller may distribute a flow entry to the VTEP, which may help VTEP to forward the packets sent from the source node to the destination node to the determined forwarding gateway.

### BACKGROUND

Cloud computing has become a common solution in information technologies currently deployed in enterprises, and virtualization widely applied and deployed in cloud computing has almost become an underlying technology mode. A Software Defined Network (SDN) is a currently popular virtualization solution, a core idea of which lies in that a control plane of the network is separated from the forwarding plane (also referred to as a data plane), and the control plane of the network, e.g., all of decisions on respective forwarding actions, is transferred to a centralized controller, so that a forwarding device forwards it using flow entries issued by a controller.

### BRIEF DESCRIPTION OF THE DRAWINGS

FIG. 1 is a structural diagram of a deployed VXLAN network in an example of the present disclosure;

FIG. 2 is a schematic hardware structural diagram of a device where an SDN controller is located in an example of the present disclosure;

FIG. 3 is a flowchart illustrating a method for layer-3 forwarding in a VXLAN in an example of the present disclosure;

FIG. 4 is a schematic diagram illustrating two forwarding paths formed by two forwarding gateways in the VXLAN illustrated in FIG. 1 in an example of the present disclosure; and

FIG. 5 is a logic structural diagram of a device for layer-3 forwarding in a VXLAN in an example.

### DETAILED DESCRIPTION

The SDN is generally deployed in three solutions including a solution based upon a dedicated interface, a solution based an overlay network, and a solution based upon an open protocol, where the overlay refers to a virtualization technology mode overlying the network architecture to virtualize the network by encapsulating a packet (or a data frame) into another packet.

The VXLAN is a currently commonly supported overlay protocol, and the VXLAN has become an option for building a large two-layer data center. Since the data center tends to be responsible for important service functions, there is a large amount of data traffic, and the performance of the VXLAN is a crucial factor influencing the services.

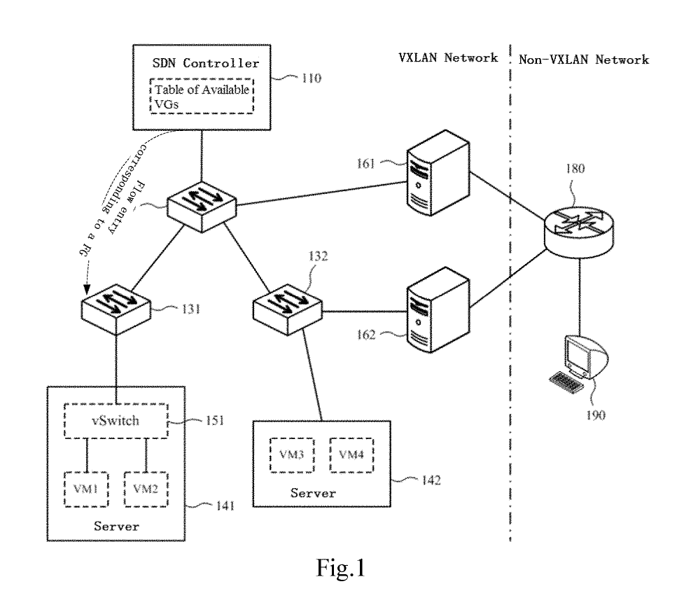

FIG. 1 illustrates a possible networking structure of a VXLAN. In this example, a switch 120 is connected with a VXLAN Tunnel End Point (VTEP) 131 and a VTEP 132, a VXLAN gateway 161 is connected with the switch 120, and a VXLAN gateway 162 is connected with the VTEP 132. A server 141 is connected with the VTEP 131 and the VTEP 132. A server 142 is connected with the VTEP 132; and a router 180 in a non-VXLAN network is connected with the VXLAN gateways 161 and 162. A host 190 in the non-VXLAN network is connected with the router 180. Wherein, the VTEP 132 is being run on a switch.

A Virtual Machine (VM) 1, a VM 2, and a virtual Switch (vSwitch) 151 are being run on the server 141. The VTEP 131, as an access device of the VM 1 and the VM 2, connects the VM 1 and the VM 2 with the VXLAN through the vSwitch 151. A VM 3 and a VM 4 are being run on the server 142. The VTEP 132, as an access device of the VM 3 and the VM 4, connects the VM 3 and the VM 4 with the VXLAN. The VM 1 and the VM 2 access the VXLAN 10, and the VM 3 and the VM 4 access the VXLAN 20. VMs accessing the same VXLAN belong to the same logic layer-2 network, and may communicate with each other at layer-2. VMs accessing different VXLANs are isolated from each other at layer-2 and may communicate with each other through layer-3. The SDN controller 110 establishes secured channels respectively with the respective network devices mentioned above, and exchanges packets with the respective network devices over the secured channels to issue a flow entry, to inquire, to report a state, and perform other functions. It shall be noted that FIG. 1 only illustrates the SDN controller 110 being connected with the switch 120, although the SDN controller 110 may also be connected with the other network devices.

By way of an example in which the VM 1 sends an initial packet to the host 190, if the VM 1 determines that the packet of the host 190 needs to be forwarded at the layer-3, by comparing an IP address of the host 190 with a locally configured subnet mask, then a destination IP address of the packet sent to the host 190 is determined as the IP address IP-190 of the host 190, and a destination Media Access Control (MAC) address of the packet is determined as an MAC address MAC-161 of a locally configured default gateway (providing the default gateway provided on the VM 1 is the VXLAN gateway 161). The packet sent by the VM 1 reaches the VTEP 131 through the vSwitch 151.

Since the packet is an initial packet of a data flow, the VTEP 131 will not find such a flow entry in a local flow table that matches the packet sent by the VM 1 to the host 190. Then the VTEP 131 may send the packet to the SDN controller 110 according to SDN protocol.

The SDN controller 110 stores information and data about the respective VMs, vSwitches, VXLAN gateways, and other managed devices in its management domain, e.g., IP addresses and MAC addresses of the VMs, the connected vSwitch, the VXLANs where they are located, etc., VTEP IP addresses of the VXLAN gateways, the respective VXLANs where they are located, information about routes to the non-VXLAN, etc. The SDN controller 110 may acquire from such information that the VM 1 belongs to the VXLAN 10, and the VTEP IP of the default gateway thereof is the IP-161. Then the SDN controller 110 may send a flow entry to the VTEP 131 to instruct the VTEP 131 to perform VXLAN-encapsulating on the packet. The encapsulated packet includes an outer-layer destination IP address of IP-161, and a VXLAN Network Identifier (VNI) of 10, and the VTEP 131 sends the encapsulated packet (VXLAN packet) to the next-hop switch 120.

The VTEP 131 sends the packet to a port connected with the switch 120 after encapsulating the packet into the VXLAN packet according to the distributed flow entry from the SDN controller. After the VXLAN packet reaches the VXLAN gateway 161, the VXLAN gateway 161 de-encapsulates the VXLAN packet into the original packet. Since the destination node of the original packet is the host 190 located in the non-VXLAN network, the VXLAN gateway 161 may forward the packet by routing it to the host 190. Then the packet reaches the destination node, which is the host 190, through the router 180.

As can be apparent from the process above, the SDN controller distributes the flow entry to the VTEP according to the default gateway locally configured on the source node, and sends the packet, to be sent by the source node at the layer-3, to its default gateway. And the default gateway forwards the packet by forwarding it at the layer-3. In a large layer-2 network, network configuration of virtual machines is typically kept unchanged, so that all of layer-3 traffic on several virtual machines configured with the same default gateway will be forwarded by this unchanged VXLAN gateway. If there is a large amount of layer-3 traffic from these virtual machines, then the VXLAN gateway may easily be congested, which may lower the performance of the network seriously.

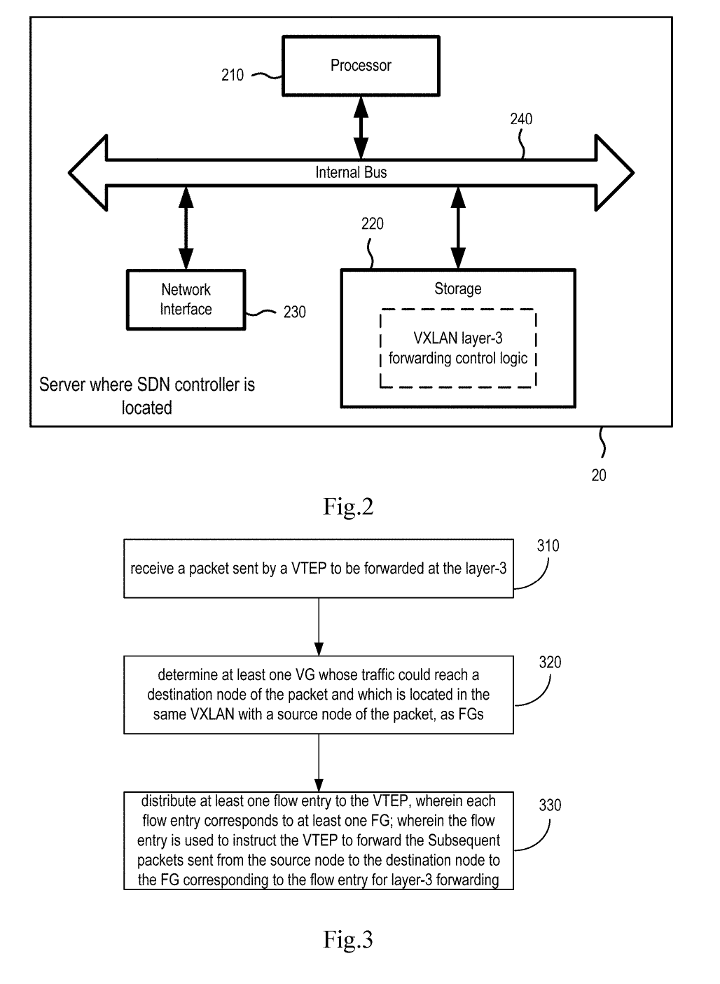

In an example, the VXLAN layer-3 forward control logic operating on the SDN controller may distribute the layer-3 traffic dynamically to at least one of the VXLAN gateways to thereby prevent the layer-3 traffic from being concentrated on one specific VXLAN gateway. Referring to FIG. 2, a device 20 where the SDN controller is running on may include a processor 210, a memory 220, and a network interface 230, all of which are connected with each other by an internal bus 240. The processor 210 executes the VXLAN layer-3 forward control logic in the memory 220 in an operational flow as illustrated in FIG. 3.

The block 310 is to receive a packet from a VTEP to be forwarded at the layer-3.

In this example, the packet to be forwarded at the layer-3 includes a packet for which a destination node and a source node are located in different VXLANs, that is a packet to be forwarded at the layer-3 between two VXLANs; or a packet for which the destination node is in the non-VXLAN network, e.g., a packet forwarded from the VXLAN network to a non-VXLAN layer-3 physical network.

If the VTEP receives the packet sent by the source node, and does not hit such a flow entry in a local flow table that matches the packet, then the VTEP sends the packet to the SDN controller.

The block 320 is to select at least one VXLAN gateway which could reach the destination node of the packet and is located in the same VXLAN with the source node of the packet, as a forwarding gateway (FG).

As described above, the SDN controller maintains information about the respective managed devices in its management domain, including the addresses, the VXLANs, and other configuration information of the managed devices, and also connection links, routes, and other information of the managed devices. The SDN controller may know from such information that which of the VXLAN gateways is located in the same VXLAN with the source node of the packet, and could reach the destination node of the packet, and selects at least one of them as the FG.

For layer-3 forwarding between the two VXLANs, if the VXLAN gateway (VG) in the VXLAN where the source node is located may forward the packet to the VTEP of the VXLAN, at which the destination node is located, it means such VXLAN gateway could reach the destination node. For layer-3 forwarding to the destination node in the non-VXLAN, if the VXLAN gateway in the VXLAN where the source node is located has a route to the destination node, it means such VXLAN gateway could reach the destination node.

Upon reception of each packet to be forwarded at the layer-3, the SDN controller may search for VGs which are located in the same VXLAN with the source node of the packet and could reach the destination node of the packet, according to its maintained information about the managed devices in the management domain, and then the SDN controller may select at least one of VGs as a FG. In another example, the SDN controller may store a corresponding relationship between destination nodes and VGs that could reach the destination nodes, and in this way, the SDN controller may search the stored corresponding relationship to select a VG as a FG which is located in the same VXLAN with the source node of the packet and could reach the destination node of the packet.

In an example, the SDN controller stores a table of available VGs. The table includes a plurality of entries. Each entry may include the destination nodes and VGs that could reach the destination nodes. In this example, the entry may further include IP addresses of VTEPs of the VGs, VXLANs where they are located, etc. These entries may be generated automatically by the SDN controller from its maintained information about the management domain. If the SDN controller receives a packet, sent by the VTEP, to be forwarded at the layer-3, then the SDN controller may search the table of available gateways to find a VG which could reach the destination node of the packet and is located in the same VXLAN with the source node of the packet as the FG.

In another example, the SDN controller may generate a table of available VGs including all the traffic reachable destination nodes from the stored information about the management domain, and update automatically the entries in the table of available VGs if there is a change in network topology. Thus the SDN controller may search the table of VGs to find all the VGs that could reach the destination node for the packet, upon each time when it receives the packet, sent by the VTEP, to be forwarded at the layer-3.

Upon reception of the packet, sent by the VTEP, to be forwarded at the layer 3, the SDN controller may firstly search the table of available VGs for entries including destination nodes. If such entries are found, then the SDN controller may retrieve all VGs that could reach the destination node of the packet from these entries; otherwise, the SDN controller may find a VG that could reach the destination node for the packet from the stored information about the management domain, and generate and store the entries in the table of available VGs. In another example, an aging mechanism may be enabled for the entries in the table of available gateways to reflect in a timely manner a varying state of the network and to avoid the table from becoming too large.

The SDN controller may determine all the VGs which could reach the destination node of that packet and are located in the same VXLAN with the source node of the packet as FGs, or may select one or more of them as FGs. In an example, the SDN controller obtains information about operating states of the VGs which are located in the same VXLAN with the source node of the packet, and selects at least one of the VGs as the FG according to the information about their operating states. Dependent upon the particular network deployment of the VXLAN network, the SDN controller may obtain the information about the operating states from such VGs that could reach that destination node, or may obtain the information about the operating states of such VGs from a network management server or a logic module performing a network management function and located on a physical server. The information about the operating states may include one or more parameters, such as operating normally or not, the amounts of traffic, utilization ratios of hardware devices, etc. The SDN controller may select the FG under a number of set conditions according to the obtained information about the operating states, for example, if there are more than two VGs that could reach the destination node and are located in the same VXLAN with the source node of the packet, then the SDN controller may determine two VGs with the lowest utilization ratios located in the same VXLAN with the source node as the FGs.

The block 330 is to distribute at least one flow entry to the VTEP sent the packet, where each flow entry corresponds to at least one FG and is used to instruct the VTEP to send the subsequent packets sent from the source node to the destination node, to a FG corresponding to the flow entry for forwarding at the layer-3.

If there is more than one FG then the SDN controller may distribute a flow entry to the VTEP to specify one or more of the FGs, or may distribute a plurality of flow entries to the VTEP to specify the different FGs in the respective flow entries.

In an example, if there are no less than two FGs, the SDN controller distributes at least two flow entries to the VTEP sent the packet, where each flow entry corresponds to at least one FG, and the respective flow entries correspond to different FGs; and each flow entry is used to instruct the VTEP to forward the packet to the corresponding FG for layer-3 forwarding. For example, for each FG, the SDN controller distributes a flow entry to instruct the VTEP to send the packet sent from the source node to the destination node, to the FG for forwarding at layer-3. The packets are those packets of the same flow with the packet sent by the VTEP to the SDN controller.

The VTEP receives and locally stores the flow entries. And the packets sent from the source node to the destination node will match at least one of the flow entries. If there is more than one matching entry, that is, there is more than one flow entry matching the packet in the flow table sent from the SDN, the VTEP may take these matching entries as a plurality of paths of an equivalent route, and processes and forwards a plurality of packets respectively by using the different matching entries. This function may be performed by enabling the equivalent route locally on the VTEP or remotely from the network management server or the SDN controller. Thus such packets sent by the source node to the destination node, generally defined as packets of a same flow, will be distributed to the different FGs for load balancing.

The SDN controller distributes each flow entry to the VTEP, and particularly the flow entry instructs the VTEP to modify the destination MAC address of the packet sent from the source node of the packet to the destination node into an MAC address of one of the FGs corresponding to the flow entry, to VXLAN-encapsulate the packet taking a VTEP IP address of the corresponding FG as an outer-layer destination IP address, and to send the packet to the corresponding FG.

The VXLAN operates in a tunnel forward mode in which an Ethernet packet is encapsulated at a UDP transport layer, and VXLAN is full-connection network deployment. In other words, all of the peripheral devices (including the VTEPs and the VXLAN gateways) of a VXLAN are connected with each other over point-to-point logic tunnels, where the VG may use its VTEP IP address to set up the logic tunnel with the other VTEPs. The VXLAN packet after encapsulation is sent by a source peripheral device to a destination peripheral device over the logic tunnel, and in some applications, the peripheral device at the source end determines the particular destination peripheral device from the VNI, the inner-layer destination MAC address (the destination MAC address in the original packet before encapsulation), and the outer-layer destination IP address (the destination IP address encapsulated outside the original packet) in the VXLAN packet. In this example, the VXLAN packet to be forwarded at the layer-3 may reach the FG over the logic tunnel when the inner-layer destination MAC address thereof is the MAC address of the FG, and the outer-layer destination IP address is the VTEP IP address of the FG.

As described above, the destination MAC address of the packet, sent by the source node, to be forwarded at the layer 3 is the MAC address of the default gateway configured locally by the source node. In this example, the FG may not be the default gateway configured on the source node. Thus, the flow entry distributed by the SDN controller instructs the VTEP to modify the destination MAC address of the packet into the MAC address of the FG corresponding to a matched flow entry, and to VXLAN-encapsulate the packet by taking the VTEP IP address of the corresponding FG as the outer-layer destination IP address, so that the VXLAN packet after encapsulation reaches the FG over the logic tunnel between the VTEP and the FG.

In this example, one or more of the VGs which could reach the destination node and are located in the same VXLAN with the source node of the packet are determined as FGs for forwarding at layer-3. This arrangement could allow the layer-3 traffic of the source node not to necessarily pass through the default gateway, to thereby distribute the traffic of the source node dynamically so as to improve the performance of the network; and if there is more than one distributed flow entry, then the load of traffic of the source node may be further balanced to avoid the traffic from being concentrated on a specific VXLAN gateway. Moreover, the SDN controller may select the FG according to the operating state information to thereby direct the traffic from a heavily loaded VXLAN gateway dynamically to a lightly loaded VXLAN gateway so as to further improve the performance of the network.

In another example of the application, the SDN controller maintains a table of available VGs, and upon reception of the packet, sent by the VTEP, to be forwarded at the layer-3, the SDN controller determines VGs in the table of available VGs which could reach the destination node of the packet as candidate VGs. And then the SDN controller may further determine, as the FG, at least one candidate VGs located in the same VXLAN with the source node of the packet.

Still taking the network illustrated in FIG. 1 as an example, the table of available VGs on the SDN controller 110 includes the entries depicted in Table 1:

TABLE 1

| Destination IP | | VTEP IP address of available |
|---|---|---|
| address | Available gateway | gateway |
| . | . | . |
| . | . | . |
| . | . | . |
| IP-VM3 | VXLAN gateway 161 | IP-161 |
| IP-VM3 | VXLAN gateway 162 | IP-162 |
| IP-190 | VXLAN gateway 161 | IP-161 |
| IP-190 | VXLAN gateway 162 | IP-162 |
| . | . | . |
| . | . | . |
| . | . | . |

In Table 1, the destination IP address is the IP address of the destination node of the packet.

If the VM 1 sends a packet to the VM 3 for the first time, then supposing a default gateway configured locally by the VM 1 is the VXLAN gateway 61, a source MAC address of the packet is MAC-VM1, a source IP address thereof is IP-VM1, a destination MAC address thereof is MAC-161, and a destination IP address thereof is IP-VM3.

The packet sent by the VM 1 reaches the VTEP 131. The VTEP 131 does not find such a flow entry in the local flow table that matches the packet sent by the VM 1 to the VM 3, and sends the packet to the SDN controller 110.

The SDN controller 110 extracts the destination IP address of IP-VM3 in the packet, searches the table of available VGs for the VGs that could reach IP-VM3. In this example the VG 161 and the VG 162 are determined as VGs that could reach the destination node of the packet. Since both of the two VGs belong to the VXLAN 10 where the source node VM 1 is located, the SDN controller 110 determines both of the VGs as FGs, and generates and distributes two flow entries to the VTEP 131, where each flow entry corresponds to a FG, where:

The flow entry corresponding to the VG 161 is used to instruct the VTEP 131 to replace with MAC-161 the destination MAC address in the packet with the source IP address of IP-VM1, and the destination IP address of IP-VM3, and then encapsulates the packet into a VXLAN packet with the VNI of 10. After encapsulation the outer-layer destination IP address is IP-161, and the outer-layer destination MAC address is MAC-120. The encapsulated packet (VXLAN packet) will be forwarded over the logic tunnel to the VXLAN gateway 161, where MAC-120 is the MAC address of the next-hop node of the VXLAN packet, i.e., the switch 120 connected with the VTEP 131.

The flow entry corresponding to the VXLAN gateway 162 is used to instruct the VTEP 131 to replace with MAC-162 the destination MAC address in the packet with the source IP address of IP-VM1, and the destination IP address of IP-VM3, and encapsulates the packet into a VXLAN packet with the VNI of 10, the outer-layer destination IP address of IP-162, and the outer-layer destination MAC address of MAC-120. The VXLAN packet will be forwarded over the logic tunnel to the VXLAN gateway 162, where MAC-120 is the MAC address of the next-hop node of the VXLAN packet.

The VTEP 131 receives and locally stores the two flow entries distributed by the SDN controller. Since there are two flow entries matching the packet sent by the VM1 to the VM3, the VTEP 131 applies the two flow entries alternately as two paths of an equivalent route. The VTEP 131 may process and forward each packet of the same flow by using one of the flow entries. Thus the plurality of packets sent by the VM 1 to the VM 3 will be distributed to the two FGs for layer-3 forwarding, where the formed two forwarding paths are as illustrated in FIG. 4.

In an example, providing a flow entry corresponding to the VG 162 is applied on some packet, the VTEP 131 may modify the destination MAC address of the packet and encapsulates the packet and then forwards the VXLAN packet.

The packet after encapsulation, may successfully reach the VM 3. The process is illustrated as follows. The VTEP 131 sends the VXLAN packet to the VG 162 over the tunnel between the VTEP 131 and the VG 162 according to the VNI, the inner-layer destination MAC address (MAC-162), and the outer-layer destination IP address (IP-162) of the VXLAN packet. The VG 162 receives and de-encapsulates the VXLAN packet into the original packet. Since the destination node VM 3 is located in the VXLAN 20, the packet is further VXLAN-encapsulated and then sent to the VTEP 132 over the tunnel of the VXLAN 20, and is de-encapsulated by the VTEP 132 and then forwarded to the VM 3.

For a packet sent from the VXLAN network to the non-VXLAN network, the packet may be processed on the respective nodes in a similar process as above before reaching the FG, and may be processed with existing technology after reaching the FG, so a repeated description thereof will be omitted here.

In correspondence to the process described above, the application further provides a device for layer-3 forwarding in a VXLAN, which is applicable to an SDN controller, where the device may be embodied in software, or may be embodied in hardware or in a combination of hardware and software. If the device is embodied in software, then the device may be logically embodied by the processor 210 in FIG. 2 executing the VXLAN layer-3 forward control logic in the memory 220. For example machine readable instructions stored in a non-transitory storage medium and executable by a processor. If the device is embodied in hardware it may be implemented by an application specific integrated chip (ASIC), field programmable gate array (FPGA) or the like. In some examples the device may be embodied as a combination of hardware and software executed by a processor.

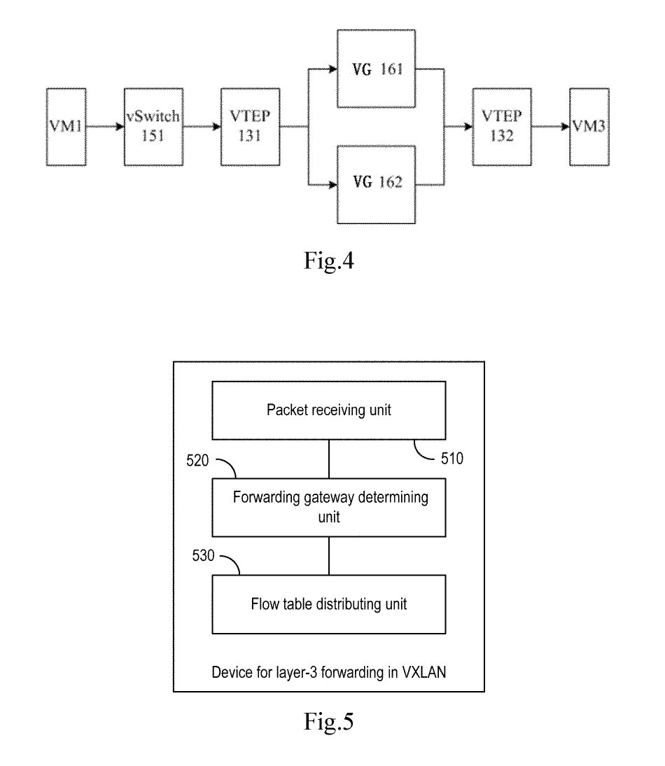

FIG. 5 illustrates a device for layer-3 forwarding in a VXLAN in an example of the application, which is located on an SDN controller, where the device functionally includes a packet receiving unit 510, a FG determining unit 520, and a flow table distributing unit 530, where the packet receiving unit 510 is configured to receive a packet, sent by a VTEP, to be forwarded at the layer 3; the FG determining unit 520 is configured to determine, as a FG, at least one VG which could reach the destination node and is located in the same VXLAN with a source node of the packet; and the flow table distributing unit 530 is configured to distribute at least one flow entry to the VTEP, where each flow entry corresponds to at least one FG and instructs the VTEP to send the packet, sent from the source node to the destination node, to one of the FGs corresponding to the flow entry for forwarding at the layer 3.

The each flow entry may particularly instruct the VTEP to modify a destination MAC address of the packet sent from the source node to the destination node into an MAC address of one of the FGs corresponding to the flow entry, to VXLAN-encapsulate the packet taking a VTEP IP address of the corresponding FG as an outer-layer destination IP address, and to send the packet to the corresponding FG.

In an example, the SDN controller stores a table of available VGs including entries which include the destination node, and VXLAN gateways that could reach the destination node; and in this example, the FG determining unit 520 is particularly configured to search the table of available gateways for the VXLAN gateways that could reach the destination node, and to determine as the FG at least one of the VGs, which is located in the same VXLAN with the source node of the packet.

The FG determining unit 520 may include an operating state obtaining module and a FG selecting module, where the operating state obtaining module is configured to obtain information about operating states of the VXLAN gateways which are located in the same VXLAN with the source node of the packet, and could reach the destination node of the packet; and the FG selecting module is configured to select at least one of the VXLAN gateways as the FG according to the information about their operating states.

The packet to be forwarded at the layer-3 includes a packet of the destination node in a non-VXLAN network, or a packet of the destination node in a different VXLAN from that of the source node.

The foregoing disclosure is merely illustrative of examples of the disclosure but not intended to limit the disclosure, and any modifications, equivalent substitutions, adaptations, thereof made without departing from the spirit and scope of the disclosure shall be encompassed in the claimed scope of the appended claims.

1. A method for implementing layer-3 forwarding of a Virtual Extensible Local Area Network (VXLAN), applied to a Software Defined Network (SDN) controller, the method comprising:
receiving a packet, sent by a VXLAN Tunnel End Point (VTEP), to be forwarded at the layer-3;
determining at least one VXLAN gateway (VG) that could reach a destination node of the packet and which is located in the same VXLAN with a source node of the packet, as a forwarding gateway (FG); and
distributing at least one flow entry to the VTEP, wherein each flow entry corresponds to at least one FG; wherein the flow entry is configured to instruct the VTEP to forward the packets sent from the source node to the destination node to the FG corresponding to the flow entry for layer-3 forwarding.

2. The method according to claim 1, wherein each flow entry is further configured to instruct the VTEP to modify a destination MAC address of the packet into an MAC address of one of the FGs corresponding to the flow entry, to VXLAN-encapsulate the packet taking a VTEP IP address of the corresponding FG as an outer-layer destination IP address, and to send the VXLAN packet to the corresponding FG.

3. The method according to claim 1, wherein the SDN controller stores a table of available VGs comprising entries and each entry comprises the destination node, and of the VGs that could reach the destination node of the packet; and
determining, as the FG, the at least one VG that could reach the destination node of the packet and which is located in the same VXLAN with the source node of the packet, comprising: searching the table of available VGs for VGs that could reach the destination node of the packet, and then determining at least one of the VGs which is located in the same VXLAN with the source node of the packet as the FG.

4. The method according to claim 1, wherein determining, as the FG the at least one VG that could reach the destination node of the packet and which is located in the same VXLAN with the source node of the packet, comprises:
obtaining information about operating states of VGs that could reach the destination node of the packet and which are located in the same VXLAN with the source node of the packet; and
selecting at least one of the VGs as the forwarding gateway according to the information of their operating states.

5. The method according to claim 1, wherein the packet to be forwarded at the layer-3 is a packet with the destination node in a non-VXLAN network, or a packet with the destination node in a different VXLAN from the source node of the packet.

6. A device for implementing layer-3 forwarding of a Virtual Extensible Local Area Network (VXLAN), applied to a Software Defined Network (SDN) controller, characterized in that the device comprises:
a packet receiving unit configured to receive a packet sent by a VXLAN Tunnel End Point (VTEP) to be forwarded at the layer-3;
a FG determining unit configured to determine at least one VXLAN gateway (VG) could reach a destination node of the packet and which is located in the same VXLAN with a source node of the packet, as a forwarding gateway (FG); and
a flow entry distributing unit configured to distribute at least one flow entry to the VTEP, wherein each flow entry corresponds to at least one FG; wherein the flow entry is used to instruct the VTEP to forward the packets sent from the source node to the destination node to the FG corresponding to the flow entry for layer-3 forwarding.

7. The device according to claim 6, wherein each flow entry is further used to instruct the VTEP to modify a destination MAC address of the packet into an MAC address of one of the FGs corresponding to the flow entry, to VXLAN-encapsulate the packet taking a VTEP IP address of the corresponding FG as an outer-layer destination IP address, and to send the VXLAN packet to the corresponding FG.

8. The device according to claim 6, wherein the SDN controller stores a table of available VGs comprising entries including the destination node, and the VGs could reach the destination node of the packet; and
the FG determining unit is configured to search the table of available VGs for VGs that could reach the destination node of the packet, and then determining as the FG at least one of the VGs which is located in the same VXLAN with the source node of the packet.

9. The device according to claim 6 or 8, wherein the FG determining unit comprises:
an operating state obtaining module configured to obtain information about operating states of the VGs that could reach the destination node of the packet and which are located in the same VXLAN with the source node of the packet; and
a FG selecting module configured to select at least one of the VGs as the forwarding gateway according to the information of their operating states.

10. The device according to claim 6, wherein the packet to be forwarded at the layer-3 is a packet with the destination node in a non-VXLAN network, or a packet with the destination node in a different VXLAN from the source node of the packet.

11. A machine readable storage medium, which is stored with computer instructions which are executed by a processor of an SDN controller to:
receive a packet, sent by a VXLAN Tunnel End Point (VTEP), to be forwarded at the layer-3;
determine at least one VXLAN gateway (VG) that could reach a destination node of the packet and which is located in the same VXLAN with a source node of the packet, as a forwarding gateway (FG); and
distribute at least one flow entry to the VTEP, wherein each flow entry corresponds to at least one FG; wherein each flow entry is used to instruct the VTEP to forward the packets sent from the source node to the destination node to the FG corresponding to the flow entry for layer-3 forwarding.

12. The machine readable storage medium according to claim 11, wherein each flow entry is further used to instruct the VTEP to modify a destination MAC address of the packet into an MAC address of one of the FGs corresponding to the flow entry, to VXLAN-encapsulate the packet taking a VTEP IP address of the corresponding FG as an outer-layer destination IP address, and to send the VXLAN packet to the corresponding FG.

13. The machine readable storage medium according to claim 11, wherein the SDN controller stores a table of available VGs comprising entries including the destination node, and the VGs that could reach the destination node of the packet; and
the determining, as the FG, the at least one VG that could reach the destination node of the packet and which is located in the same VXLAN with the source node of the packet, comprises: searching the table of available VGs for VGs that could reach the destination node of the packet, and then determining as the FG at least one of the VGs which is located in the same VXLAN with the source node of the packet.

14. The machine readable storage medium according to claim 11, wherein the determining, as the FG, the at least one VG that could reach the destination node of the packet and which is located in the same VXLAN with the source node of the packet, comprises:
obtaining information about operating states of the VGs that could reach the destination node of the packet and which are located in the same VXLAN with the source node of the packet; and
selecting at least one of the VGs as the forwarding gateway according to the information of their operating states.

15. The machine readable storage medium according to claim 11, wherein the packet to be forwarded at the layer-3 is a packet with the destination node in a non-VXLAN network, or a packet with the destination node in a different VXLAN from the source node of the packet.
